(19) United States
(12) Patent Application Publication
(10) Pub. No.: US 2009/0063184 A1
(43) Pub. Date: Mar. 5, 2009

(54) Method For Automatic Project File Reconstruction and Batch Processor

(75) Inventors: Fred McBagonluri, East Windsor, NJ (US); Artem Boltyenkov, Lawrenceville, NJ (US); Lavlesh Lamba, Piscataway, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS HEARING INSTRUMENTS INC., Piscataway, NJ (US)

(21) Appl. No.: 11/847,419

(22) Filed: Aug. 30, 2007

(51) Int. Cl. G06Q 50/00; G06F 17/30

(52) U.S. Cl. 705/2

(57) ABSTRACT

A method and appertaining system for performing the method is provided in which the modeling and detailing of a hearing aid shell can be done at a remote site, while the work order handling and the actual manufacture are performed at a local site without the need to transmit large STL files from the remote site to the local site. The local site is able to construct an STL file from data defining the original undetailed impression and a project file containing the detailing algorithms from the remote site. The hearing aid shell may then be manufactured from the STL file.

### BACKGROUND

The present invention relates to the manufacture of hearing aid shells, and more specifically to the field of file reconstruction for 3D hearing aid models that are manufactured in a different location than the models are stored.

When a user orders a hearing aid, a model of the wearer's ear is created so that the hearing aid shell can have an optimum fit. Traditionally, a manually intensive process was used to form the hearing aid shell. In recent times, computer aided design, modeling, and manufacturing has taken over many of the formerly manual tasks. One of the primary distinguishing areas is in the creation, use, and storage of the shell shape in a digitized 3D model. Hearing aid shells that are defined digitally as 3D models are then capable of being manipulated by a computer.

However, these 3D shell models should ideally be stored in a standardized format so that they can be understood by multiple applications. One common format for these files is the “STL file”, where the STL (stereolithography) file is well-known file type in the stereolithography field that describes a raw unstructured triangulated surface by the unit normal and vertices (ordered by the right-hand rule) of the triangles using a three-dimensional Cartesian coordinate system. Other suitable 3D file formats may be utilized in the system described below as well—file formats such as the Initial Graphics Exchange Specification (IGES). Although the term “STL file” will be used herein to describe the invention, it should be understood that this is simply shorthand for describing any 3D modeling file that is used.

In certain systems, the detailing and modeling of the hearing aid may not be done at the same location as its manufacture—therefore, the hearing aid model data is separate from the manufacturing systems that may utilize the data. This may be done for a variety of reasons. For example, the potentially manually intensive job of modeling and detailing may be performed in a location where labor is relatively inexpensive. Or, the modeling and detailing may be done in an area where a particular expertise has developed.

Unfortunately, the STL files can be quite large in size in order to define the 3D hearing aid shell shape with an adequate resolution. An exemplary size for such a file might be approximately 1 MB, and a particular site might require 2000 of these files per day. This large size creates a problem in that the finished 3D files must usually be moved from the remote modeling and detailing facility to the local production site, and the industry as a whole suffers from the lack of an efficient mechanism to transfer these large files from the remote to the local site.

### SUMMARY

The present invention addresses the problems identified above in a system where both the initial order and the final manufacturing operation are done locally, but the modeling and detailing work between these is done remotely. A hearing aid order originates from a local source. The local source holds information from an acoustician or other professional who initially interacted with a patient and obtained the impression data either physically or converted/obtained the impression data in a digital form.

The information related to a work order for the hearing aid shell is sent to a remote site with, e.g., a point cloud (which is relatively small, compared to an STL file) that defines a 3D undetailed ear impression. This initial 3-D shell model is then detailed and modeled remotely, with an accurate historical logging of activities, and this history of applying the algorithms that are used to model and detail the shell are saved in a project file that is small and can be easily transferred from the remote modeling and detailing site to the local manufacturing site.

The local site provides a batch processor tool that can automatically reconstruct the voluminous STL files from the point cloud information and the project file containing the detailing and modeling algorithms at a local site and eliminate the need to transfer very large STL files over the network. The system provides an easy procedure to allow remote modeling and detailing work on the work orders in different production facilities. Furthermore, the tool enables automated replication of work orders for remakes, eliminating user intervention that is currently persistent in industry manufacturing sites across the globe.

Therefore, advantageously, the present invention provides the ability to reconstruct the STL files on-site given inputs of a project file that exists in a backend database and the original raw impression data file. There is no need to transfer large STL files over the network, and this is beneficial since currently the size of the STL files is a large obstacle on the way to allowing remote 3D shell modeling and detailing. To achieve the reconstruction, the batch processor tool parses the database, detects the finished project files without corresponding finished STLs, and automatically generates finished STLs from the project file. Afterwards, the process stores the resulting STLs in the database.

The system can operate on any existing 3D modeling and detailing systems project files. Finished STL files are regenerated from the project files in the database and the reconstructed STL files are written back into the database. The process can run independently from the user interactions, so that no users are required. An order number, as defined herein, is a unique number associated with all patient data, components, options, and parts necessary for the manufacture of a monaural or binaural hearing aid order.

### DESCRIPTION OF THE DRAWINGS

The invention is described in more detail below with reference to various preferred embodiments illustrated in the drawings and appertaining descriptive portions following.

FIG. 1 is a flowchart illustrating the process and data flow in an embodiment of the invention; and

FIG. 2 is a block diagram illustrating the primary components according to an embodiment of the invention.

### DETAILED DESCRIPTION OF THE PREFERRED EMBODIMENTS

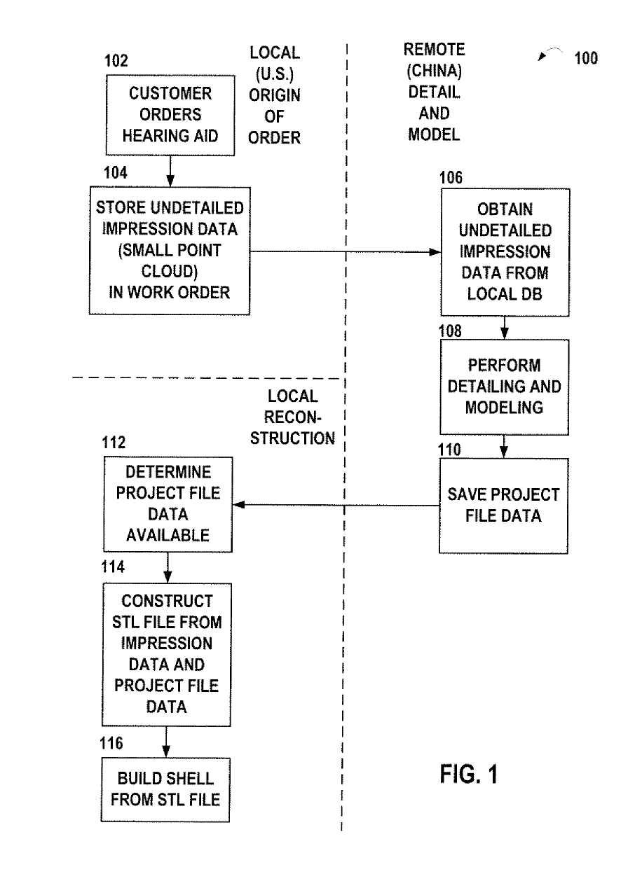

FIG. 1 illustrates the basic flow 100 of processes and information in the system in a context of an exemplary embodiment of the invention which involves the U.S. (local—for order origination and later file reconstruction) and China (remote—detailing and modeling). In this scenario, a local affiliate facility located in the U.S. receives an order from a customer 102. The order, which includes (among other things) undetailed impression data in a form of, e.g., a relatively small point cloud, is entered into a database 104 locally in the U.S. and assigned for modeling and detailing to a remote modeler and detailer in China.

The modeler in China is notified, by any suitable communication mechanism, that there is a work order for him/her to act on in the database in the U.S., and the modeler in China loads this work order with its associated data 106, including the impression data, performs the appertaining modeling and detailing 108, starting with the initial impression data model. As the modeler performs each modeling and detailing step, information about what is being done at that step is being logged into a project file. The logging of the steps takes up a relatively small amount of memory. These log files may contain information about slicing operations and planar coordinates, rotations, shaping, adding, etc., and also include information to permit sequence reconstruction.

Once complete, the modeler saves the appertaining work order information (the “finishing order”) back into the database 110 of the local system in the U.S. The process of saving the finishing order is known as “committing” work order. Upon saving of the work order, the project file containing the history of applying modeling and detailing algorithms is also be saved into the database 110. This historical file is much smaller than the STL file, from which the manufacturers work.

The local system determines, by e.g., polling or an event, if the project file data is available 112, and if so, utilizes an algorithm to construct an STL file from the impression data and the project file data containing the history of applying modeling and detailing algorithms 114. This provides the necessary STL file 116 from which the shell may then be built.

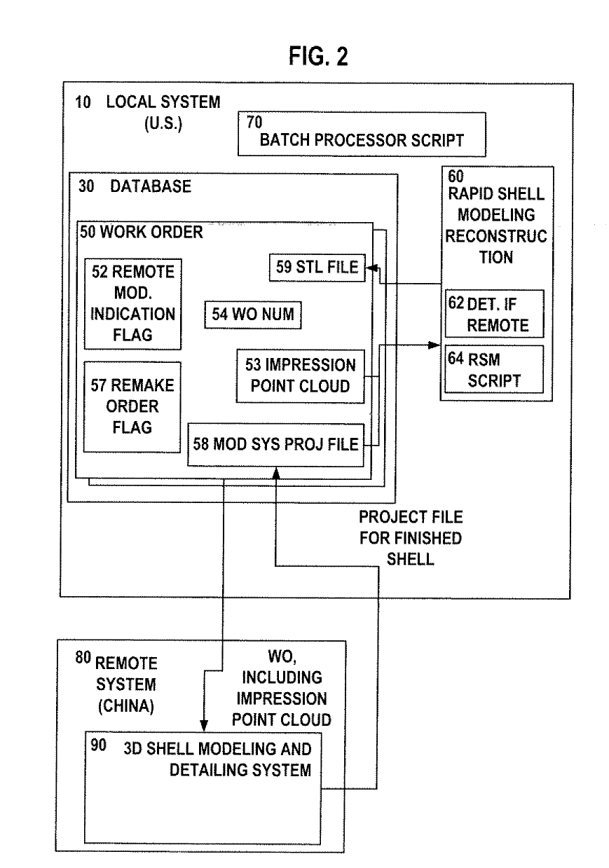

FIG. 2 is a block diagram of the appertaining system elements. A local system 10 comprises a database 30 containing work order records 50. When a work order 50 for a hearing aid is locally created, it contains information related to the shape of an undetailed hearing aid impression 53, which may, e.g., be in the form of a point cloud, which is stored in the work order 50 in the database 30

The remote system 80 is then notified by any suitable mechanism or network-based protocol, that a work order 50 is available for modeling and detailing in the database 30 on the local system 10, and the remote system 80 then pulls down the work order information 50 from the database 30 located in a local system 10. Note that the system could also operate as a push system, with the local system 10 pushing the relevant work order 50 information to the remote system 80.

This impression information 53 is then sent along with other pertinent work order information 50 to the remote system 80, where a 3D shell modeling and detailing system 90 are used to perform modeling and detailing functions. The remote modeling and detailing system 90 may comprise any degree of manual and automated activities, including up to a fully automated system. This modeling system 90 creates a modeling system project file 58 that comprises a list of algorithms that were applied to build the finished shell from the ear impression point cloud 53, and steps along with any relevant associated data pertaining to the steps/algorithms that would permit later reconstruction.

This information (the project file 58 and other pertinent work order information) is then sent from the remote system 80 to the local system 10 that originated the work order and is saved into the relevant work order 50 of the database 30 of the local system 10—this process of saving the finishing order is referred to as “committing” the work order 50.

It is further possible that the work order 50 is an order for a remake of an existing shell (e.g., where the hearing aid user loses their hearing aid) without impression data, as opposed to an order for a new hearing aid that would have impression data 53. Such a remake could be signaled by, e.g., a remake order flag 57. The handling of a remake work order 50 is very similar to that of the normal work order 50, except that it is a work order 50 that has previously been modeled, detailed and saved to the database 30. This means that remake work orders 50 have, in addition to what a normal work order has, the project file 58 from previous modeling. Therefore, the remote office 80 can load this work order, pull up the old project file 58 from the database 30, modify the project file 58 and save the work order 50, including the modified project file 58, back into the database 30. The project files could be saved according to difference version numbers or simply older ones can be overwritten, depending on user requirements.

The Hearing Aid Shell Modeling and Detailing System (HASMDS) system 60 may determine whether a work order 50 is a remote work order or not (i.e., one that was modeled and detailed on a remote system), which indicates whether the RSM should use the impression point cloud 53 and project file 58 to construct an STL file 59 or not. If the detailing and modeling is done locally, then the STL file 59 can be directly created and stored without being generated by the project file. Or, alternately, the project file could be generated even if modeled and detailed locally in the event that further changes are desired remotely at some other time. This could be achieved by utilizing a unique site or country identification code that is embedded within the work order identifier. For example, U.S. a U.S. work order number might be C07NO00001, a Canadian work order might be C07C000001, and a French work order might be C07F000001, etc. Therefore, in this example, the HASMDS 60 would only have to look at the fourth character to determine whether the work order is remote or not by comparing the fourth character of work order number with the local character for the local affiliate.

If the work order 50 is a remote work order, upon committing the work order 50 for manufacture, the HASMDS system 60 sets a Boolean remote modeling indication flag/key value 52 contained within the work order 50 to TRUE (i.e., this is a work order modeled remotely); otherwise, it is set to FALSE (i.e., this is a work order modeled locally). This flag can also be construed as an “STL file needs to be processed flag”. Once the STL file has been created, the flag is set to false, and the work order 50 appears to the batch processor 70 as if it were a locally detailed record 50.

An exemplary illustration may be used to illustrate the concept. U.S. work order numbers 54 might have an “N” as their fourth letter always. So for HASMDS software run in the U.S., all U.S. work orders 50 will appear to be local and a special flag 52 may be utilized to determine whether it was modeled and detailed locally or remotely. It is also within the scope of the invention to use other suitable mechanisms to determine whether the modeling and detailing was performed locally or remotely.

When the HASMDS is run in a remote location (e.g., China), there are a lot of different work orders from all over the world. Upon committing the completed work order 50 to the database 30, the HASMDS may assign the flag 52 to the work order. In this example, China does not have its own database and always works with other databases. However, this invention in not limited to the cases where the remote location does not have own database. Thus, if the Chinese HASMDS is working with information from a U.S. database 30, the Chinese HASMDS will set the remote modeling indication flag 52 to true and not save the finished STL (it will only save the project file). If the HASMDS work order is a U.S. work order operated on locally in the U.S., the HASMDS will set the flag 52 to false and the finished STL will be copied. This clarifies how exactly the work order is determined as remote: by ID (by the HASMDS in the remote location) or by flag 52 (by the HASMDS in the local location).

The implementation of determining whether a work order 50 is a remote work order could be done by a software module 62, such as a plug-in on the HASMDS system 60. In such a case, upon committing the work order 50, the HASMDS system 60 sets the remote modeling key value 52 of the work order record 50 to TRUE; otherwise, if the plug-in is not installed, it is set to FALSE. The local system 10 will not transfer the finished STL file 59 on-site (to the manufacturer) if, upon committing the work order 50, the remote modeling key value 52 was set to TRUE.

Since the HASMDS 60 can be a scriptable application, an internal scripting language may be used to write an HASMDS work order reconstruction script template 64, which loads a work order 50 with a project file 58 from the database 30 and commits it. This invention is not limited to Hearing Aid Modeling and Detailing Systems that have a scripting language built-in. If the application itself is not scriptable, the same result can be achieved by using any of the existing applications that allow writing user interaction scripts for other applications (e.g., Rational Robot).

At some periodic interval, e.g., each night (or in response to a triggering event), a batch processor script 70 runs on the local system 10 against the database 30 and detects the pertinent work orders 50, i.e., those in which the remote modeling key value 52 of the work order 50 is set to TRUE. The batch processor script 70 then modifies the work order HASMDS reconstruction script template 64 by replacing a placeholder work order number in the template 64 with the real work order number 54 from the database 30 if the work order 50 with the remote modeling key value 52 of the word order 50 set to TRUE contains a project file 58 from the remote system 80. The batch processor 70 may be triggered periodically or in a timed manner, but can also be event driven by any suitable mechanism.

On every work order 50 with the remote modeling key value 52 of the work order 50 set to TRUE, the batch processor 70 runs the modified work order reconstruction script 64 that saves the resulting STL file 59 into the work order 50 in the database 30. As soon as the STL file 59 for the current work order 50 in saved into the database 30, the remote modeling key value 52 of the work order 50 is set by the batch processor 70 to FALSE to prevent a re-execution.

In any case, the above-identified software can be designed to run on any form of general purpose computer comprising data inputs and outputs, a user interface, a processor and a memory for storing executable code to be executed on the processor. The executable code can be stored on a computer-readable media and loaded into the memory of the general purpose computer.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The word mechanism is used broadly and is not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

TABLE OF REFERENCE CHARACTERS

| | |
|---|---|
| 10 | local system |
| 30 | database |
| 50 | work order |
| 52 | Boolean remote modeling key value/indication flag |
| 53 | impression point cloud or other representation of the initial |
| | impression data, undetailed impression data |
| 54 | work order number |
| 57 | remake order flag |
| 58 | modeling system project file |
| 59 | detailed shell file, STL file |
| 60 | HASMDS reconstruction system/routines |
| 62 | algorithm for determining if remote |
| 64 | HASMDS script file |
| 70 | batch processor script |
| 80 | remote system |
| 90 | modeling and detailing software |
| 100 | system flow |
| 102-116 | flow steps |

What is claimed is:

1. A method for processing a hearing aid order, comprising:
generating a hearing aid order on a local system;
creating a work order record in a database of the local system;
storing original impression data representing 3D data for at least one of an unmodeled and undetailed impression in the work order record;
transferring the work order record to a remote site;
at the remote site, performing a detailing and modeling operation using the undetailed impression data, and saving a project file comprising a list of algorithms or steps and associated data used for the detailing and modeling;
transferring the project file from the remote system to the work order record of the local system;
examining work order records on the local system and determining if at least one of a modeled and detailed shell model should be created;
at least one of a modeled and detailed shell model should be created, then creating a detailed shell 3D model file from the impression data and the project file and storing the at least one of a modeled and detailed shell file to be associated with the work order record; and
manufacturing a hearing aid shell from the detailed shell file.

2. The method according to claim 1, further comprising:
in the step of transferring the project file from the remote system, setting a remote detailing and modeling flag in the work order record indicating a remote detailing and modeling operation was performed; and
wherein determining if a detailed shelf model should be created comprises examining the flag in the work order.

3. The method according to claim 1, wherein the examining of the work order records is trigger by periodic polling.

4. The method according to claim 1, wherein the examining of the work order records is triggered by an event.

5. The method according to claim 1, wherein the undetailed impression data is stored as a point cloud.

6. The method according to claim 1, further comprising:
running a batch processor script on the local system against a database comprising the work order records to determine which work order records were modeled and detailed remotely.

7. The method according to claim 6, wherein the batch processor script operates on a reconstruction script template containing a placeholder work order number and replaces the placeholder work order number with an actual work order number for which work order the shell was modeled and detailed remotely.

8. The method according to claim 1, wherein the at least one of a modeled and detailed shell 3D model file is an STL file.

9. The method according to claim 1, wherein an attribute of a work order number of the work order is utilized to determine whether the work order is a remotely modeled and detailed work order.

10. The method according to claim 9, wherein the attribute is a character representative of a country of origin.

11. A method for processing a hearing aid reorder, comprising:
generating a hearing aid reorder on a local system;
creating a work order record in a database of the local system;
providing an indicator in the work order record that this is a reorder;
transferring the work order record to a remote site;
at the remote site, performing a reorder detailing and modeling operation using the undetailed impression data and original project file, and saving a reorder project file comprising a list of algorithms or steps and associated data used for the reorder detailing and modeling;
transferring the project file from the remote system to the work order record of the local system;
examining work order records on the local system and determining if a reorder at least one of a modeled and detailed shell model should be created;
if the at least one of a modeled and detailed shell model should be created, then creating at least one of a modeled and detailed shell 3D model file from the impression data and the reorder project file, and storing the at least one of a modeled and detailed shell file to be associated with the work order record; and
manufacturing a hearing aid shell from the modeled and detailed shell file.

12. An apparatus for processing a hearing aid order, comprising:
a local system comprising:
a database having a plurality of work order records stored therein, the records comprising unmodeled or undetailed impression 3D data;
a network communications output via which remote work order information can be sent;
a processor; and
a rapid shell modeling reconstruction module having executable software code that runs on the processor;
the apparatus further comprising:
a remote system comprising:
a processor;
a shell modeling and detailing system having executable software code that runs on the processor;
an input for accepting remote work order information from the local system;
an output for providing a finished shell project file to the work order information on the local system;
wherein the reconstruction module of the local system comprises an input for accepting the finished shell project file and the unmodeled or undetailed impression 3D data, processing algorithms that act in the input data, and provide, at an output of the module, a detailed shell 3D model from which a manufactured shell can be made.
